(19) United States
(12) Patent Application Publication
(10) Pub. No.: US 2022/0014043 A1
(43) Pub. Date: Jan. 13, 2022

(54) Direct Wireless Charging Systems, power sources, power generation and power supply for a surface and airborne micro-organism and matter identification system using drones and robots.

(71) Applicant: Keith Louis DeSanto, St Petersburg, FL (US)

(72) Inventor: Keith Louis DeSanto, St Petersburg, FL (US)

(21) Appl. No.: 17/338,729

(22) Filed: Jun. 4, 2021

Related U.S. Application Data
(60) Provisional application No. 63/047,176, filed on Jul. 1, 2020.

(51) Int. Cl. H02J 50/10; H02J 50/50

(52) U.S. Cl. CPC H02J 50/10; H02J 2310/44; H02J 2310/42; H02J 50/50

(57) ABSTRACT

Implementation, utilization and management of power sources, power generation and power supply, recharging of chargeable devices, transfer of power to and from storage devices, powering drones and robots with power storage devices for a surface and airborne micro-organism and matter identification system using artificial and machine learning algorithms. The entire application including all energy sources, power generation components, hardware, software, mobile components and ancillary hardware components will be referred to as the “system”.

Implementation, utilization and management of power sources, power generation and power supply, recharging of chargeable devices, transfer of power to and from storage devices, powering drones and robots with power storage devices for a surface and airborne micro-organism and matter identification system using artificial and machine learning algorithms. The entire application including all energy sources, power generation components, hardware, software, mobile components and ancillary hardware components will be referred to as the “system”.

This new system of power sources, power generation and power supply for our surface and airborne micro-organism and matter identification system employs artificial intelligence and machine learning algorithms and uses Direct Wireless Charging Systems “DWCS” also known as Wireless Power Transfer “WPT” for the drones, robots and watercraft.

The following list of energy sources and power generation encompasses the entire system known as AIMLPowerapp for Artificial Intelligence and Machine Learning Power Application.

AIMLPowerapp utilizes many different single source or combinations of power (energy producing) sources. The list of power sources that AIMLPowerapp use are electricity (alternating current), batteries (direct current), fossil fuels, natural gas (combustion), fuel cells, hydrogen fuel cells (separation of hydrogen into protons and electrons), nuclear power (fusion/fission), solar energy (direct current), thermal (heat) and energy produced from wind, water (hydro), compressed air and magnetic. Also included is the burning of organic materials that produces high pressure steam called biomass. Burning of coal, geothermal energy (heat from earth), tidal energy are also included in this list. Different forms of energy are used such as, electrochemical, kinetic, pressure, potential energy (static electricity), electromagnetic, chemical, and thermal. The power sources for the AIMLPowerapp can each operate independently or in one or more combinations for power.

The prior list of energy sources provides the energy or fuel to generate power for the AIMLPowerapp utilizing electric generators, electric engines, turbines, combustible engines, steam engines, fuel cells, water wheels and energy storage devices. Energy storage devices are systems which store energy in various ways such as batteries and capacitors. Nano-materials can also be used for energy storage devices using nano-particles, nano-wires or any other component that is in the nano size range.

### Overview of Surface and Airborne Micro-Organism and Matter Identification System

### How It Works

As detailed in our many other USPTO and PCT applications, we use different combinations of servers (connected and stand-alone), desktop computers, artificial intelligence and machine learning algorithms, drones, robots, mechanical arms, conveyor belts, lasers, sensors, high definition microscope lenses, light microscopes, electron microscopes, x-ray machines and NMR machines, microscope plates, static electricity, blacklights, docking stations that—upload and download data to and from drones and robots/provide power to/charge/recharge drones and robots, data transmission equipment, laptops, tablets, cell phones, transmission lighting equipment (morse code), sensors, environmental sensors, and cantilevers to identify surface and airborne micro-organisms, matter, allergens, molds, bacteria, viruses, pollutants and biological germs.

The system works with a single power source or combinations of power sources where the combinations of power sources can be added or removed depending on the artificial intelligence and machine learning algorithms. The main component of the system is the Direct Wireless Charging System “DWCS” otherwise known as Wireless Power Transfer or “WPT” for the drones and robots and watercraft.

The system component of the Direct Wireless Charging Systems that the application uses is powered by all types of power sources. Depending on the indoor or outdoor application, whether land is available for solar panels or wind turbines, flowing water is nearby or certain types of fuel are nearby such as oil and gas pipelines that can be tapped into, the dwcs can be deployed quickly. The DWCS can utilize many types of power sources while the frequent source of power for the system is electricity. The power to the DWCS can be from electricity and batteries that can be recharged and store energy or can be directly powered by turbines, combustible engines, solar panels, wind turbines (wind energy), water (water mill/hydro power) or nuclear power.

The list also provides power sources that produce power to store in power storage devices such as batteries, capacitors and coils such as superconducting “superconducting coil” magnetic energy storage. The power source most commonly used in our system for power creation and storage is the use of electric generators and turbines. Other forms of power creation and storage use combustible engines for our drones and robots that utilize fossil fuels and natural gas. Hydrogen fuel cells are also used to power our drones, robots and watercraft.

### Overview of Application

The application has four distinct purposes:
To determine what power sources are available and which power sources can be used efficiently.
What power source will have the least impact on the environment
Use of Artificial Intelligence and Machine Learning applications for management of power
The cheapest form of energy that is presently available, that be implemented with costs in mind (machine learning algorithms)

The entire application of AIMMOIA and the power to the application is based on self-management utilizing artificial Intelligence and machine learning. The entire application consists of available power sources, power generation, power storage and power management of identification of airborne and surface matter system. Power source and power choice is constantly learned by the application. An example (example 1) is if a remote village without electricity can be implemented with solar panels for charging the application and having the application run (scan for viruses) at night while it charges during the day. If the platform determines through geographical databases that running water is close by, the platform will send drones and robots to determine the rate of water flow (is the depth deep enough to place hydro power equipment) and if so, how far will the cables or “DWCS” need to be to provide the power.

The application through machine learning can also calculate what is the cost estimate as well as what barriers are there to construction (mountains/ability to place construction equipment). The databases of the application constantly are updated utilizing web crawlers over the internet, maps, satellite images, building permits, recognition technology of the lay of the land, water sources, land for solar panels and environmental data such as humidity, altitude, temperature, season (winter, spring summer or fall). This information also is learned by the system to predict specific occurrences that may affect future decisions.

AIMMOIA is explained in detail in our various other USPTO and PCT filings. This application was invented to provide the power required for the operation of AIMMOIA.

The invention offers autonomous power management, power efficiency, lower costs to operate the application and reduces the time to complete tasks while limiting the impact on the environment. One example is (example 2) if power is running low for whatever reason, the system shuts down some components such as if more than one drone and robot is being used or if the power source being used is electricity and a power outage arises, the system will operate on backup power and determine how much power is needed to bring back the drones and robots and shut the system down until electrical power is restored. Another example (example 3) is if natural gas is being used in drones and robots utilizing combustible engines and the natural gas tanks for refueling the drones and robots is running low, the system will switch to the backup power source if one is available, if not, the system will resort to example 1.

This invention is based on power supply, power management, learning about power sources, their causes and effects on environments using artificial intelligence, machine learning and matter identification. The management of the power sources leads to learning while maintaining the least possible impact on the environment with cost based efficiently. The power application is managed by and the data is learned and projection models are formed using machine learning and artificial intelligence algorithms. An example (example 4) is when the machine learning learns that in a high temperature, high humidity climate or an area or high altitude, the application recommends combustible engines (that mix with fuel and air) not be used. The ratio of air to fuel becomes an issue and the engine may not operate at peak capacity. Natural and gas and fossil fuel powered combustible engines do not perform at peak performance in high temperatures and in high altitudes. Operation of combustible engines in high altitudes causes lower efficiency because less air is available for mixture with fuel. Reduced oxygen in high altitudes can lead to inefficient, sluggish engine performance and sometimes stalling.

This application can work with a single source of power or a combination of power sources.

The list of hardware for our AIMMOIA requires power are either normal sized, nano-technology or a combination of both.

Many sources that provide power to our applications are environmentally safe with cost efficient technology. This application utilizes many different single source or combinations of power.

Power generation for our application is in the form of turbines and engines that are powered by fossil fuels, electricity, batteries, hydrogen fuel cells, natural gas and or nuclear energy.

The energy sources provide the energy to drones and robots and their electric motors, turbines and combustion engines while also providing the power to other stationary components. The combination of one or more power source for powering the engines (combustible, turbine, battery cells, panels) of drones and robots, the platform of creating static electricity (for attraction of micro-organisms to the platform), the microscopes, high definition lenses, conveyor belts, lasers, sensors, cantilevers, blacklights, transmission equipment (wired, wireless, bluetooth, satellite and cellular), light communication equipment (morse code), lighting and transporting the drones and robots from one place to another outdoors at long distances (over 10 miles). Some distances can be over 1,000 miles that the drones and robots need to be transported to.

The Artificial Intelligence and Machine learning platform through power consumption, environment, cost and type of the power application, specific identity of micro-organism/matter, and their specific consumption of power is all learned by the algorithms that rely on the entire system of hardware working in combination with each other. Predictions from the data learned are also part of the system.

The engines may also be powered by electricity, battery power, solar panels, wind turbines, water power (water wheel/water mill) and wireless charging systems such as Dynamic Wireless Charging Systems “DWCS”.

There is much prior art regarding the mechanics and application of AC and DC (alternating current and direct current) hydrogen fuel cells, natural gas, nuclear power, battery power and magnetic energy may also be used in certain circumstances.

This new application is the application and management of power sources to an artificial intelligence platform and machine learning micro-organism identification platform that is managed by separate artificial intelligence and machine learning algorithms and their entire combination of power sources and hardware.

### List of Power Sources

Batteries -rechargeable and non-rechargeable.

Rechargeable Batteries (and sometimes non-rechargeable) are used in combination in our application with the following power producing components. A battery is defined as a device containing an electric cell or a series of electric cells storing chemical energy that can be converted into electrical power, usually in the form of direct current. Our drones and robots in certain applications use Dynamic Wireless Charing Systems that utilize rechargeable batteries. Sometimes when the dwcs is delayed in assembly, batteries that cannot be recharged and need to be discarded will be used depending on the type and area of application. An example (example 5) of this may be a structure whose electricity is not usable due to power outages from storms or other issues such as acts of god, war and government/military interference.

Hydrogen Fuel Cells

Hydrogen Fuel cells are defined as hydrogen fuel that is created using renewable energy instead of fossil fuels. Hydrogen fuel cells provides the fuel to combustible engines and turbines to create power. Basically, it is the process of separating hydrogen molecules into protons and electrons producing energy.

There are many publications regarding hydrogen fuel cells and more detailed information can be obtained from the world-wide web. For purposes of this invention, the application of power by hydrogen fuel cells (more than one) to power the entire system of applications is part of the invention itself.

Nuclear Power

Nuclear power is the use of nuclear reactions in a nuclear reactor to produce power. The power is obtained by nuclear fission decay and nuclear fusion. Splitting of isotopes of uranium and plutonium produce the power known as fission. The power produced can be steam or electricity from turbines, generators and combustible engines. This power can be environmentally catastrophe when not managed correctly but can also be environmentally safe and non-toxic to the environment. This nuclear power application can be used in remote areas where no other power source is available but a quick setup of power is needed or on a nuclear powered ship. An example (example 6) of this would be the military can use the invention on their nuclear-powered ships and armored vehicles and tanks for biological germ identification. The application may be best suited in remote areas such as the desert. Simply plugging in our system or components of our system depending on what is required (also managed by the AI/ML platform) into the militaries nuclear power source, is akin to plugging in an iron at home through an electrical outlet. The power systems on their carriers, ships are nuclear powered. The different mobile biological germ identification applications from previous USPTO and PCT filings are explained in the filings.

Natural Gas

Natural gas is a combusable gas (used in combustible engines) from petroleum deposits and geological formations. It can also exist in a liquefied state for applications of certain micro-organism and airborne and surface matter identification. Drones, robots and natural gas-powered generators can power the entire system of hardware including the transportation vehicles used to transport the natural gas to the application site. Tapping into a natural gas pipeline nearby is ideal for cost, environmental impact and time as in many drones and robots can be used without worry of cost, transport of the gas or recharging or using the dwcs. The natural gas can also be used to power natural gas generators to supply power to the hardware.

### Dynamic Wireless Charging Systems

Electricity, fossil fuels, natural gas, hydrogen fuel cells, nuclear power, solar panels, water mills (hydro power), wind turbines, magnetics (magnetic fields) and rechargeable batteries all either separately or in combination with each other provide the power to the Dynamic Wireless Charging System that explicitly powers the drones and robots at times may produce electrostatic charge. In a very wet environment (raining), the moist air may cause challenges to micro-organism and matter attraction to surfaces. The wireless charging pads can be placed on the ground, walls or ceilings where the ground pads specifically charge the robots but the drones can use the pads on the floor, the ceilings and the walls for charging. On some occasions, a floating vehicle may use the charging pads that are suspended above a body of water. Pads may also be placed on or above a roof.

Definition of Dynamic Wireless Charing Systems using Artificial Intelligence and Machine learning is the charging of drones and robots wirelessly while they are in motion. The power is transferred over the air from a stationary transmitter to the receiver coil in a moving drone, robot or watercraft. The application can be easily installed for long term power for the drones, robots and their sensors or lasers. The power pads can be placed on grounds (indoor and outdoor), affixed to ceilings and or walls. The pads can be used inside structures, on top or affixed to outside of structures or used under ground in tunnels and on bridges. This application increases the scan time of our drones and robots while reducing the weight. The entire dwcs power system with all its permutations and combinations are managed by an artificial intelligence and machine learning platform. Power generation to the “DWCS” can be any one source or combination of sources from the list of power sources above.

The system of applications are managed by algorithms through selection from 6 options:

### 1—Size of Area—Level I, II or III

Is the facility to be scanned small (under 2,500 cubic feet) usually residential, small corporate office or a doctor's office. Labeled Size level I. If not, move to next level.

Is the facility to be scanned medium (over 2,500 cubic feet but less than 25,000 cubic feet) Labeled Size level II. If not, move to next level.

Is the facility to be scanned is large (over 25,000 cubic feet) Labeled Size level III

### 2—Type of Area

Outside of a structure, the system ask questions

Is the facility to be scanned completely closed in

Is the facility to be scanned partially open such as a sports stadium

Is the facility to be scanned mostly open, with roof and one or two walls such as a pole barn or an open barn or an open sided building.

Is the facility to be scanned in a remote area. GPS and data from maps will show the geographical area through databases and the databases are updated through satellite and machine learning algorithms.

### 3—Type of Structure

Residential, corporate, warehouse, farm, municipal building, stadium, hospital, assisted living facility, remote area (barren) remote from land for temporary or permanent solar panels, remote without flowing water, remote with no power assets (dwcs is required with generators)

### 4—Power Buildout, Possibilities

There are readily “A”ccessible power sources Level AI

There are Power sources that must be “B”rought in Level BII

Power sources that should be “C”onstructed Level CIII.

The AI/ML system chooses from what is available, then it chooses what can be the best fit and finally, what will be the most efficient power source with the least impact on the environment.

### The Application at Work—Lasers, Sensors, Drones and Robots

Before any identification scan commences, drones and or robots are dispatched to survey the possibilities of power sources and their implementation. The drones and robots utilize batteries or combustible engines where natural gas is the first choice. Then the robots and drones may construct and lay and assemble the DWCS system depending on the area, square miles of pads that need to layed and what type of terrain. Indoor deployment of the dwcs system is easier, less costly where outdoor environment pose challenges for drone and robot assembly of the system. The artificial intelligence “AI” system utilizes data from past scans and learns from that scan data (machine learning) which includes but is not limited to: power possibilities, possible power sources, possible power resources, power predictions, pattern discovery and if an area for scanning can be best serviced by the application of “dwcs” either within proximity of the area being scanned or miles away from the area being scanned.

The first question that the system asks itself, does the facility (structure) have electricity indoors or if the scan is outdoors, are there any electrical outlets? This is done by using “power recognition technology” where drones and robots use cameras, video and voltage testers (some non contact) and receptacle analyzers to detect the presence of electrical voltage.

If so, no need for drones and robots to scan for other power sources. Manual Input of that data to AI/ML “Machine Learning” platform can be done by humans to save time. The next data pool is the occurrence of power outrages from the source of electricity. If the occurrence is low (under 5 times a year in the last two years and the time to correct is less than 24 hours), the AI/ML platform will switch to efficiency of power and backup power sources with the level of impact on the environment. If the electric power is generated by the burning of coal, the AI/ML platform then switches to implementation of an alternative power source. With this data, the platform learns so in the future, a very small pool of data will be needed and initial scanning by drones and robots will determine what area does it categorize as and what power sources are available by cameras, sensors and power recognition technology “PRegTek”

The PRegTek application also utilizes specific AI/ML algorithms and hardware such as lasers, environmental sensors, high definition lenses, drones, robots and cantilevers to identify possible power sources and construction of power generation systems. An example (example 7) would be that of a village in a third world country where a disease has spread through the village and is killing people. With AIMMOIA, immediate identification of the pathogen (or disease-causing matter) can be ascertained while the AI/ML system scouts out a permanent continual power generation application for constant monitoring. If the village is located near a mountain top, the system will calculate the amount of power that may be generated from wind turbines and can be erected and the AI/ML platform will determine what is needed, the cost of such power, the amount of how much power can be generated by a single turbine and how many years of service will the turbine and AIMMOIA application be stable before maintenance is needed. The AI/ML system can be one or more platforms and the AI/ML algorithms will determine what is needed.

Another example (example 7) are combinations of power system manages whether more or less power is needed and what is the best type of power that is available. If flowing water has been identified in an area where mold scanning is required by the AI/ML system, the AI/ML algorithms will determine if a temporary power generation system is needed or there must be a permanent power generation system. Our microbe/matter identification platform can be erected on top of a water fall (or simply flowing water) to power the entire platform. The excess charging of the platform can be saved to many different other components such as batteries that are either stationary or in motion such as a unmanned vehicle that will transport that excess power to another area whether near or far. The transport may use the flowing water, ground air or a combination of all 3.

### Power for the DWCS Static Electricity Application

One of most important aspects of our AIMMOIA is the application of static electricity used to attract matter to a surface for identification under light microscopes, electron microscopes, “high definition lenses” x-ray machines or NMR. The power generation for the dwcs can also create the static electricity to be transferred to a surface for microbe and matter attraction and then identification. The system manages, provides and applies the static electricity by way of motion from the drones and robots utilizing the “dwcs” When the drone and robot travel over the pads for charging (ground, wall and ceilings), plates consisting of glass, ceramic, plastic, rubber, plexiglass affixed to the bottom of the drones and robots travel over wool, fur, fabric or plastic sheets affixed (may be slightly raised) to the pads slightly touching the plate on the drone or robot to the material to create the static electricity charge.

### List of Components from Application that Require Power

Servers, desktop computers, laptops, tablets, smart phones drones, robots (with mechanical arms), conveyor belts, light microscopes and electron microscopes and all other types of high definition lenses (both battery operated, rechargeable and wired for AC electrical current), wired and wireless data transmission equipment (including satellite and cellular towers and fiber optics), blacklights, lasers, sensors, Direct Wireless Charging system components, lighting equipment, static electricity machines (electromechanical generator), cantilevers, land and water transport vehicles that transport the drones, robots and application components to and from areas that require scanning,

### Combination of Power Sources

This application uses different types of power source's and combinations of those power sources. The combination power sources are utilized for many different reasons.

The areas of lists of power sources are listed below

Nuclear Military-armored vehicles as well as larger and smaller nuclear-powered ships can simply plug our system directly into the ships electric panels or outlets or use a nuclear-powered turbine directly.

Solar and water-remote areas and power outrages from storms and other instances may rely on both.

Natural gas fossil fuels may be best for remote areas with no baron land (for solar panels) nor flowing water.

Batteries and electricity—for residences in developed cities

### Additional Combination of Power Sources

Combustible engines without generators or recharging so that the sensors can be powered by batteries. Batteries will need to be replaced but can spend more time scanning if a dwcs is not available.

Nuclear energy power—where propulsion of the drone or robot is used but the sensors, high definition lenses are powered by an electric generator powered by hydrogen fuel cells.

### Power Sources for Stationary Applications

For most indoor applications in developed cities with the luxury of electricity, solar power, wind power from turbines and at times hydro power—the power to the application not only has choices but also combinations when one power source works with another. An example (example 8) would be when a residence or business has relied on electricity to power the dwcs but a blackout (no power source for many days) has occurred. Backup power sources are initiated by the AI/ML system by determining the following information:

When was the last scan?

Was the result identification of a pathogen, pollutant, allergen or mold?

If not, taking time and the result of the level of threat of the pathogen and or biological threat into consideration, the AI/ML system decides how many scans will be needed with what power source that is available. If the backup source is batteries that hold a limited charge (not rechargeable, not recharging because of a technical issue or life of batteries is complete), then the scan time is limited while the number of scans are limited to conserve power.

If the backup source of power is combustible engines, the AI/ML system will determine how much power is left, divided by time of scans needed by taking into consideration the past scan time, what was scanned, and what were the results as in matter and or microbe identified and what threat it is. The AI/ML platform (System) may determine that a combination of power sources will extend the power source until time of repair, and or replacement of power system.

Backup power sources for the application can be battery storage, large stationary storage tanks (or mobile tanks on vehicles such as tank trucks or tankers on water) for natural gas and or fossil fuel tanks, hydrogen fuel tanks (stationary or mobile tankers or trucks), turbines powered by nuclear energy (or the nuclear energy turbines used to make and store energy in batteries), solar panels used to provide or store energy to batteries, hydro turbines for future storage for future access to backup power or a combination of one or all.

Power sources, backup power for Direct Wireless Charging Systems and matter and microbe attraction and identification.

Our drone and robot wireless charging system has four main components to it, the artificial intelligence and machine learning algorithms, the power provided to it, the backup power to the entire system and the electro static charge application to microscope plates using drones and robots for matter and microbe attraction and identification.

Initial power. When the dwcs is initialized, the AI/ML system is also deployed concurrently. The dwcs consists of charging pads, transmission and receiving coils to send and receive the charge. The DWCS can be set up to communicate with humans by text, pictures, diagrams, voice and morse code using lights, symbols, sounds or a combination thereof when transmission of information requires methods other than bytes and bits. The system consists of charging pads connected to a power source (described above in this application) that can be up to 10 feet in width and 10,000 miles in length. The pads can be sections (a nanometer up to 25 feet) that connect with each other that require assembly or can be laid down to interlock with each other. The pads can be made with metal, plastic, rubber, graphite, or a combination of all materials. The transmission equipment can be made up of glass, (fiber optic cable) copper (copper wire for wired communication), coaxial cable, lights, speakers, fiber optic cable and or lasers, wired and wireless (bluetooth, cellular, satellite). The system can be suspended in air by cables, and or trusses, suspended over water, attached to the ground (outdoor) or walls and ceilings (indoors). The drones, robots are equipped with coils to receive the charge from the pads wirelessly. The drones and robots hover or drive close to fabric and or plastic to create static electricity or the fabric and or wool can be placed anywhere where the drone or robot can contact the fabric or plastic or material to create static electricity. The system can also create a static electric charge by having an electrostatic machine installed on the dwcs itself. With an electrostatic charging machine, the plates would not need to be attached to drones and robots to create the charge. This aspect uses more power to supply power to the electrostatic machine whereas the other method of “self” (as in drones and robots) static electricity creation by the touching of fabric and plastics does not require power.

Separate AI/ML algorithms are utilized with the dwcs system. The artificial intelligence system manages all aspects of the hardware, software applications such as chatbots applications and mobile vehicles while the machine learning algorithms learn. The dwcs machine learning algorithms learn from power usage in different circumstances (hydro power to the dwcs as opposed to electricity), how much power is needed to scan different environments (minus 30 degree temperatures as opposed to 120 degree temperatures “Fahrenheit”) where the ML learns from sensor data of altitude, humidity, population of people, living conditions and density of living quarters (dorm rooms in colleges to log cabins in woods) habits and behaviors of employees of corporations and business, residents and their habits and behaviors in their homes to campers living in tents.

The DWCS Drone and Robot Direct Wireless Charging Systems or WPT Wireless Power Transfer is uses inductive power transfer technology to transfer power over the air from a pad embedded or placed on the ground, on walls or ceilings to a coil or plate attached to the drone or robot to charge the imbedded rechargeable battery in the drone and robot. The ground, walls or ceilings have power lines, power pads or both that have electrical power flowing through them. The power may be generated from any of the power application mentioned above in this application. The application can use either conducting plates (use of electric fields) or conducting coils (use of magnetic fields) and capacitors (storage of the energy from those fields). The electrified pads (ground, wall ceiling) transfer power to the plates or coils (drones and robots).

The drones and robots each maintain either a transmitting coil or transmitting plate.

The transmission of electricity through the air by creating a magnetic field between two wires is basically how the system works.

Put two metal wires close together but not touching.

Put electric current through the wire on the right.

The wire to the left will now have current.

Creating a coil of wire will increase the field.

Move the wires closer and the better the application works. Automobiles using the dwcs have more space between the charging ground pads/wires and the bottom of the automobile where the space between the charging ground pads/wires and the bottom of the drone/robot is much less and a more efficient charging mechanism is produced.

The entire system can be nano-technology sized, normal everyday contemporary sized or a combination of both.

1. An application to implement, utilize and manage power sources, power supply and power generation, recharging of chargeable devices, transfer of power to and from storage devices, drones and robots with power storage devices for a surface and airborne micro-organism and matter identification system using artificial and machine learning algorithms.

2. An application to implement, adopt and manage power sources and supply, power generation, recharging of power devices and transfer of power to storage devices for a surface and airborne micro-organism and matter identification application consisting of drones with power storage devices, circuit boards, robots with power storage devices, storage devices, microscopes, conveyor belts, servers, desktop computers, laptop computers, tablets, cell phones, lasers, sensors, mechanical arms, data transmission equipment, cantilevers, fiber optic cables, static electricity producing machines, Direct Wireless Charging Applications (“DWCS”/“WPT”) utilizing artificial intelligence and machine learning systems and platforms.

3. An application in claims 1 and 2 where the entire system is powered by single source of or combinations of electric generators, electric engines, turbines, combustible engines, steam engines, fuel cells, batteries, water wheels to produce power using the energy sources of electricity, batteries, fossil fuels, natural gas, fuel cells, hydrogen fuel cells, nuclear power, solar energy, thermal, energy produced from wind, flowing water, compressed air, magnetic energy, biomass energy, geothermal energy, tidal energy and coal burning.

4. An application in claims 1 through 3 where drones, robots and static electricity applications utilize a Direct Wireless Charging System “DWCS” or Wireless Power Transfer “WPT” System that operate autonomously by artificial intelligence and machine leaning platforms and systems.

5. An application in claims 1 through 4 where the system produces static electricity to attract micro-organisms and matter to a surface for identification.

6. An application in claims 1 through 5 where the system can be nano-technology sized, everyday normal size or a combination of both.

7. An application in claims 1 through 6 that can be used indoors, outdoors or a combination of both.

8. An application in claims 1 through 7 where the direct wireless charging system can be used by drones and robots on the ground, the walls, the ceilings, suspended by cables or placed upon trusses.

9. An application in claims 1 through 8 where the transfer of energy from one electric coil to another by an electromagnetic field to a drone or robot power storing device.

10. An application in claims 1 through 9 where static electricity is applied to a plate of solid material by the mechanical components of the system of platforms.

11. An application in claim 10 where the direct wireless charging system creates an electrostatic charge for use with micro-organism and matter attraction and identification.

12. An application in claims 1 through 11 where a drone and robot docking station is supplied power by any one or the combination of power sources.

13. An application in claims 1 through 12 where a drone and robot docking station for data transfer and management and positioning of plates for microscopes are viewed where the power is supplied by a direct wireless charging system.

14. An application in claims 1 through 13 where a direct wireless charging system charges a drone, a robot or watercraft that transfers that power to a docking station.

15. An application in claims 1 through 14 where a direct wireless charging system charges a drone or a robot or watercraft that can transfer that power charge to another system that runs on batteries.

16. An application in claims 1 through 15 where a direct wireless charging system charges a drone and a robot or a watercraft that transfers that stored power to another system that can accept that power transfer.

17. An application in claims 1 through 16 where a power charging application wirelessly transfers energy from one electric coil to another by an electromagnetic field to a drone or robot or a watercraft.

18. An application in claims 1 through 17 where a receptor coil on a drone or robot receives energy from an emitting stationary coil on the ground.

19. An application in claims 1 through 18 where a Drone and Robot maintaining a Wireless Power Transfer application use inductive power transfer technology to transfer power over the air from a pad embedded or placed on the ground, on walls or ceilings to a coil or plate attached to the drone or robot to charge the imbedded rechargeable battery in the drone and robot.

20. The application in claims 1 through 19 that can use either conducting plates (use of electric fields) or conducting coils (use of magnetic fields) and capacitors (storage of the energy from those fields) where the electrified pads (ground, wall ceiling) transfer power to the plates or coils (drones and robots).
